(19) United States
(12) Patent Application Publication
(10) Pub. No.: US 2022/0187060 A1
(43) Pub. Date: Jun. 16, 2022

(54) METHOD AND DEVICE FOR OPTICAL GEAR MEASUREMENT

(71) Applicant: Klingelnberg GmbH, Huckeswagen (DE)

(72) Inventors: Markus FINKELDEY, Hattingen (DE); Jan MERKERT, Wipperfürth (DE); Jonas STEFER, Kürten (DE)

(21) Appl. No.: 17/548,886

(22) Filed: Dec. 13, 2021

(30) Foreign Application Priority Data
Dec. 14, 2020 (DE) 10 2020 133 309.9

(51) Int. Cl. G01B 11/24

(52) U.S. Cl. CPC G01B 11/2416

(57) ABSTRACT

A method includes the steps providing a component that has toothing with a predetermined nominal geometry; providing a measuring device that has an optical measuring system; and measuring the toothing of the component by the optical measuring system, wherein measuring points are detected. The method further includes the steps of evaluating the measuring points, wherein the evaluation of the measuring points has at least the following steps: grouping the measuring points into flank groups by filtering; modeling profile segments from the measuring points of the flank groups, wherein each flank group is assigned a profile segment; and determining one or more geometric parameters of the toothing on the basis of the profile segments.

### CROSS REFERENCE TO RELATED APPLICATIONS

This application is related to and claims the benefit of German Patent Application No. 10 2020 133 309.9, filed on Dec. 14, 2020, the contents of which are herein incorporated by reference in their entirety.

### TECHNICAL FIELD

The disclosure is a method comprising the method steps of: Providing a component, wherein the component has a toothing with a predetermined nominal geometry; Providing a measuring device, wherein the measuring device has an optical measuring system; Measuring the toothing of the component by means of the optical measuring system, wherein measuring points are detected; Evaluating the measuring points. The disclosure further relates to a device for carrying out such a method.

### BACKGROUND

Optical measuring systems are becoming increasingly relevant in gear measuring technology, as they are coming ever closer to the accuracy of tactile measuring systems and often work much faster than tactile measuring systems.

Tactile pitch measurement is one of the standard measurement tasks in gear analysis and evaluation. Here, e.g. for involute toothing, all distances between involutes are measured on the left side of all teeth and the right side of all teeth, in each case on the pitch diameter and at a previously defined measuring height. A distinction is made between two tactile measuring methods, the pitch measurement via point probing exactly on the pitch diameter and the measurement of a section of the flank line on the pitch diameter, with subsequent averaging of the individual measuring points. Measurement using the flank line provides more robust results, but at the cost of a longer measurement time.

The measurement results are then compared with a nominal distance of a nominal geometry of the toothing and evaluated, for example, according to VDE or company standards or general standards such as DIN, ISO or AGMA. Measurements on deviating diameters, i.e. not directly on the pitch diameter, and one or more measuring heights are possible.

The measuring time of the tactile pitch measurement is relatively long, especially for the measurement based on the flank line, since each section of a flank line must be measured on each tooth at exactly the right diameter and height. The tactile probe must enter each tooth space without collision, must be brought into contact with the respective tooth flanks and complete two measurements in each tooth space. After the measurements within a tooth space, the probe is retracted, the gear is rotated by one tooth pitch and the measuring process is repeated for the next space.

Such a pitch measurement could in principle be carried out with a non-contact optical measuring system with a much shorter measuring time, in which the gear rotates continuously in front of the optical system, wherein no threading into the gap and no tactile probing of the flanks is required. However, known evaluation strategies used for evaluating tactile measurements lead to deviating or falsified results in connection with optical measurements. This is because the recorded measuring points of a tactile measurement and an optical measurement differ greatly from each other, especially with regard to their number and quality.

Tactile measuring systems, for example, have a very high accuracy for each specific measuring point, so that a single measuring point or a few measuring points are often sufficient to determine a geometric feature. In contrast, optical measuring systems have a lower accuracy of the individual measuring points, but detect a significantly higher number of measuring points.

In addition, optical and tactile measuring systems differ with respect to their interaction with a component to be measured. FIG. 1A, for example, schematically shows a measurement of a surface profile P which has a surface structure in the range of 10 micrometers, as indicated by the tips. In this case, a focused optical beam FS of an optical measuring system measures into the surface profile P, since its focal diameter dFs is, for example, only 20 micrometers. In contrast, a tactile measurement of the same surface profile P according to FIG. 1B causes smoothing or morphological filtering, since a sensing ball K used for sensing may have a diameter d_{K} of, for example, 500 micrometers, which is many times larger than the focal diameter d_{FS}. Furthermore, the tactile measurement does not detect dust or suspended particles which, in the context of the optical measurement, can lead to measuring points which are far away from the surface to be measured.

Evaluation strategies that are optimized for measuring points of tactile measuring systems therefore lead to deviating or falsified measurement results, as far as they are applied to measuring points that have been recorded with optical measuring systems. This makes it difficult to compare optical and tactile measurements.

### SUMMARY

Against this background, the disclosure is based on the technical problem of providing a method and a device which enable improved optical measurement of a toothing of a component, wherein in particular improved comparability with the measurement results of tactile measurements can be achieved.

The technical problem described above is solved by a method according to claim 1 and a device according to claim 10. Further embodiments of the disclosure can be seen from the dependent claims and the following description.

According to a first aspect, the disclosure relates to a method comprising the method steps of: Providing a component, wherein the component has a toothing with a predetermined nominal geometry; Providing a measuring device, wherein the measuring device has an optical measuring system; Measuring the toothing of the component by means of the optical measuring system, wherein measuring points are detected; Evaluating the measuring points. The method is characterized in that the evaluation of the measuring points comprises at least the following steps: grouping of the measuring points into flank groups by filtering; modeling of profile segments from the measuring points of the flank groups, wherein each flank group is assigned a profile segment; determination of one or more geometric parameters of the toothing on the basis of the profile segments.

The filtering of the measuring points and the resulting grouping enable improved modeling of the profile segments, since not all measuring points, but only a subset of the measuring points are evaluated. The modeled profile segments therefore more accurately reflect the actual shape of the component and enable a more precise determination of one or more geometric parameters of the toothing.

When “profile segments” are referred to in the present context, they may extend at least in sections in a profile direction and/or a flank direction of a tooth of the toothing. In particular, a profile segment may represent a profile line and/or a flank line of a tooth of the toothing. In particular, a profile segment may map a profile line of a tooth of the toothing. In particular, a profile segment may map a flank line of a tooth of the toothing.

When a toothing is referred to in the present context, it can be a pinion or a wheel of a toothed gearing. The toothing may therefore be arranged for torque and speed transmission and conversion. Alternatively, the toothing may be part of a spline.

The toothing may be involute toothing or cycloid toothing. The toothing can be a rack and pinion toothing or a Wildhaber-Novikov toothing.

Grouping the measuring points into flank groups by filtering may comprise the following method step: Radial filtering of the measuring points, wherein a plurality of the measuring points of the flank groups, in particular all the measuring points of the flank groups, lie between a predetermined minimum radius and a predetermined maximum radius. In this way, for example, head regions and/or root regions of the toothing can be masked out or sorted out or deleted, insofar as they are not to be considered for the determination of one or more geometric parameters of the toothing. In particular, it may be provided that the maximum radius is smaller than a radius of a tip circle of the toothing. It may be provided that the minimum radius is larger than a radius of a root circle of the toothing.

The grouping of the measuring points into flank groups by filtering can alternatively or additionally comprise the following method step: Profile-specific filtering of the measuring points, wherein a plurality of the measuring points of the flank groups, in particular all of the measuring points of the flank groups, are each at a minimum distance from the predetermined nominal geometry of the toothing which does not exceed a predetermined distance. Insofar as, for a measuring point, a minimum distance to the predetermined nominal geometry of the toothing is therefore greater than the predetermined distance, the measuring point is masked out or sorted out or is not assigned to a flank group or is deleted. In other words, a band or an envelope can be placed around a flank of the nominal geometry, wherein all measuring points within the band or the envelope are assigned to the respective flank group. In particular, the profile-specific filtering makes it possible to sort out or hide or delete measuring points that are attributable, for example, to disturbance variables such as dust, suspended particles or impurities.

It may be provided that both the radial filtering and the profile-specific filtering are performed. In particular, it may be provided that the profile-specific filtering is performed after the radial filtering.

Alternatively, it may be provided that the profile-specific filtering is performed before the radial filtering. Alternatively, it may be provided that the profile-specific filtering and the radial filtering are performed at least partially simultaneously.

The grouping of the measuring points into flank groups by filtering may alternatively or additionally comprise the following method step: Kinematic filtering of the measuring points, wherein a plurality of the measuring points of the flank groups, in particular all the measuring points of the flank groups, satisfy the condition that, at the time of detection of the respective measuring point, an amount of an acceleration of a machine axis of the measuring device executing a measuring movement is smaller than a predetermined threshold value. In particular, measuring points that are detected at the beginning or at the end of the measurement while one or more machine axes are accelerated more strongly and/or experience a jerk can be masked out or sorted out or deleted in this way. In other words, a run-in and/or a run-out of the measurement can be masked out or sorted out or deleted. Therefore, in particular, the flank groups do not have measuring points for whose time of detection of a respective measuring point, an amount of an acceleration of a machine axis performing a measurement movement is greater than a predetermined threshold value.

The grouping of the measuring points into flank groups by filtering may alternatively or additionally comprise the following method step: Qualitative filtering of the measuring points, wherein a plurality of the measuring points of the flank groups, in particular all the measuring points of the flank groups, satisfy the condition that during the imaging of a respective measuring point an exposure time does not fall below a predetermined exposure time and/or an intensity does not fall below a predetermined intensity. In this way, measuring points that have not been reliably imaged can be masked out or sorted out or deleted.

In particular, it may be provided that during the imaging of a respective measuring point, the intensity does not fall below a predetermined average intensity.

The exposure time and the intensity can also be calculated into a coefficient, for example in the simplest case as a product or sum or quotient, which enables an assessment of a quality of an image of a respective measuring point. In particular, it can be provided that a plurality of the measuring points of the flank groups, in particular all measuring points of the flank groups, fulfill the condition that during the imaging of a respective measuring point a predetermined minimum value of the coefficient is not fallen below or the coefficient lies in a predetermined range.

It can be provided that the grouping of the measuring points into flank groups by filtering comprises the following test step: Checking whether the number of flank groups corresponds to a double number of teeth of the toothing. If the filtering produces a number of flank groups that does not correspond to twice the number of teeth, the filtering should be adjusted. This is because after filtering, exactly one flank group with measuring points should be assigned to each tooth flank of the toothing. As far as the number of flank groups generated by filtering does not correspond to the double number of teeth of the toothing, the filtering can be adjusted and the test step can be performed again.

Alternatively or additionally, it can be provided that the grouping of the measuring points into flank groups by filtering comprises the following test step: Checking whether the number of measuring points of a respective flank group exceeds a predetermined minimum number. In particular, the subsequent modeling of the profile segments can only be performed meaningfully if there is a sufficient number of measuring points for a respective flank group. As far as the number of measuring points of a respective flank group falls below a given minimum number, the measurement can be repeated with changed measuring parameters and the number of measuring points can be checked again.

Alternatively or additionally, it can be provided that the grouping of the measuring points into flank groups by filtering comprises the following test step: Checking whether the measuring points of a respective flank group have a predetermined distribution. It can therefore be checked to what extent adjacent points exceed a maximum distance from one another and/or fall below a minimum distance from one another. The aim is therefore to achieve a distribution of the measuring points that is as homogeneous as possible. If the distribution is too uneven, the measurement can be repeated with changed measurement parameters and the distribution can be checked again.

It may be provided that one or more of the aforementioned test steps are carried out prior to modeling. This can improve the subsequent modeling.

According to one embodiment of the method, it is provided that the modeling of profile segments from the measuring points of the flank groups, wherein each flank group is assigned a profile segment, comprises one of the following method steps: Modeling at least one profile segment as a higher-order mathematical nonlinear function, or modeling a plurality of profile segments each as a higher-order mathematical nonlinear function, or modeling all profile segments each as a higher-order mathematical nonlinear function.

Therefore, curve segments or profile segments can be modeled from the measuring points by means of equalization and/or interpolation calculation, each of which curve segments or profile segments can be described as a higher-order mathematical non-linear function.

When non-linear functions of higher order are referred to in the present context, these are in particular quadratic functions, polynomial functions, power functions and the like. The choice of the appropriate function depends on the type of toothing, i.e. whether the toothing is an involute toothing, a cycloidal toothing, a rack and pinion toothing or a Wildhaber-Novikov toothing.

According to one embodiment of the method, it is provided that the modeling of profile segments from the measuring points of the flank groups, wherein each flank group is assigned a profile segment, has a plausibility check with the following method step: Creating a left averaged compensation profile segment from profile segments of left flank groups and checking a deviation of at least one profile segment of a left flank group from the left averaged compensation profile segment. The left averaged compensation profile segment may therefore be formed by averaging or superposing all profile segments of the left flank groups. An adjustment of the filtering and/or an adjustment of a measurement parameter may be performed if a deviation exceeds a predetermined threshold value.

Measurement parameters are, in particular, axis positions, axis speeds and axis accelerations of machine axes performing a measurement movement and/or parameters of the optical measuring device, such as exposure time, scanning frequency, illumination intensity, measurement angle, focus diameter and the like.

Alternatively or additionally, according to one embodiment of the method, it is provided that the modeling of profile segments from the measuring points of the flank groups, wherein each flank group is assigned a profile segment, has a plausibility check with the following method step: Checking a deviation of at least one profile segment of a left flank group from another profile segment of a left flank group. An adjustment of the filtering and/or an adjustment of a measurement parameter can be performed if a deviation exceeds a predetermined threshold value.

Alternatively or additionally, according to one embodiment of the method, it is provided that the modeling of profile segments from the measuring points of the flank groups, wherein each flank group is assigned a profile segment, has a plausibility check with the following method step: Creating a right averaged compensation profile segment from profile segments of right flank groups and checking a deviation of at least one profile segment of a right flank group from the right averaged compensation profile segment. The right averaged compensation profile segment may therefore be formed by averaging or superposing all profile segments of the right flank groups. An adjustment of the filtering and/or an adjustment of a measurement parameter may be performed if a deviation exceeds a predetermined threshold value.

Alternatively or additionally, according to one embodiment of the method, it is provided that the modeling of profile segments from the measuring points of the flank groups, wherein each flank group is assigned a profile segment, has a plausibility check with the following method step: Checking a deviation of at least one profile segment of a right flank group from another profile segment of a right flank group. An adjustment of the filtering and/or an adjustment of a measurement parameter can be performed if a deviation exceeds a predetermined threshold value.

Alternatively or additionally, according to one embodiment of the method, it is provided that the modeling of profile segments from the measuring points of the flank groups, wherein each flank group is assigned a profile segment, has a plausibility check with the following method step: Checking a deviation of the left averaged compensation profile segment from the predetermined nominal geometry. An adjustment of the filtering and/or an adjustment of a measurement parameter can be performed if a deviation exceeds a predetermined threshold value.

Alternatively or additionally, according to one embodiment of the method, it is provided that the modeling of profile segments from the measuring points of the flank groups, wherein each flank group is assigned a profile segment, has a plausibility check with the following method step: Checking a deviation of the right averaged compensation profile segment from the predetermined nominal geometry. An adjustment of the filtering and/or an adjustment of a measurement parameter can be performed if a deviation exceeds a predetermined threshold value.

Alternatively or additionally, according to one embodiment of the method, it is provided that the modeling of profile segments from the measuring points of the flank groups, wherein each flank group is assigned a profile segment, has a plausibility check with the following method step: Checking a deviation of at least one profile segment from the predetermined nominal geometry and/or from a compensation geometry, wherein the compensation geometry has been determined from the profile segments of the flank groups. For example, the compensation geometry may have been determined from the profile segments of the flank groups using the least squares method. An adjustment of the filtering and/or an adjustment of a measurement parameter may be performed if a deviation exceeds a predetermined threshold.

Alternatively or additionally, according to one embodiment of the method, the modeling of profile segments from the measuring points of the flank groups, wherein each flank group is assigned a profile segment, comprises a plausibility check with the following method step: Checking a deviation of a first profile segment of a tooth of the toothing of a first measurement from a second profile segment of the same tooth of a second measurement. Insofar as one or more teeth are measured or modeled twice or more than once, it can thus be checked whether the model is closed, i.e. whether the model can be repeatedly mapped onto itself.

According to one embodiment of the method, it may be provided that three-dimensional measuring points of at least one flank group, a plurality of flank groups or all flank groups are projected into a two-dimensional plane, in particular before profile segments are created, wherein the modeling of profile segments from the measuring points is performed in particular in the two-dimensional plane as two-dimensional profile segments.

If reference is made to “three-dimensional measuring points”, this means that three spatial coordinates are assigned to a respective measuring point, e.g. an x-value, a y-value and a z-value in a Cartesian coordinate system x-y-z. By means of a projection into a two-dimensional plane, one of these values is equated for all measured values and therefore has the same value for all measured values. For the projection, a known nominal geometry of the toothing can be taken into account, such as a helix angle, etc., so that the projection plane corresponds, for example, to a profile section or a face section and/or the measuring points are projected along their assigned flank line of the nominal geometry.

Alternatively, it may be provided that a three-dimensional profile segment of a flank group, three-dimensional profile segments of multiple flank groups, or three-dimensional profile segments of all flank groups are projected onto a two-dimensional plane.

It may be provided that a tooth pitch is one of the one or more geometric parameters of the toothing and the tooth pitch is determined on a pitch measuring circuit and/or a pitch deviation is one of the one or more geometric parameters of the toothing, such as a pitch single deviation, a pitch total deviation, a pitch jump or the like.

It may be provided that the component is moved relative to the optical measuring system while the measuring points are being recorded. In particular, the component can be rotated about an axis. In particular, the component can be rotated about an axis while the optical measuring system is stationary and/or is displaced by means of one or more linear axes.

It may be provided that the component is continuously moved relative to the optical measuring system during the detection of the measuring points. In particular, the component may be continuously rotated about an axis while the optical measuring system is stationary and/or displaced by means of one or more linear axes.

It may be provided that a focal diameter of the optical measurement system is 50 microns or less, in particular 20 microns or less.

The optical measuring system can have a point sensor which is set up for optical distance measurement. In particular, individual measuring points can be measured one after the other by the point sensor. Each individual measuring point can be recorded independently and separately from further measuring points by means of the point sensor. That is to say, by means of the point sensor, it may be possible, in particular, to acquire a single measuring point without acquiring further measuring points. Each individual measuring point can be assigned three spatial coordinates, namely e.g. an x-value, a y-value and a z-value in a Cartesian coordinate system x-y-z.

It can be provided that the point sensor for optical distance measurement has a depth resolution.

For example, viewed along an optical axis of the point sensor in a depth measuring range along the optical axis, a depth, i.e. a distance between the optically probed surface or tooth flank along the optical axis, can be measured in a predetermined coordinate system—for example a distance to an origin of the predetermined coordinate system or to another geometric reference, such as the position of a lens or the like. It can be the case that the distance measurement takes place one-dimensionally along an optical axis and three-dimensional measured values are calculated on the basis of the position of the optical measuring system.

That is, viewed along an optical axis of the point sensor, in a depth measurement range of a few centimeters or a few millimeters, or in a depth measurement range of less than one millimeter, a distance between the optically probed surface or tooth flank can be measured along the optical axis in a specified coordinate system—e.g. a distance to an origin of the desired one Coordinate system or to another geometric reference, such as the position of a lens or the like. Using the distance information from the point sensor, in particular a three-dimensional measuring point can be generated, with information on axis positions of a coordinate measuring machine carrying the optical point sensor being provided. The distance measurement may be a one-dimensionally measurement along an optical axis and three-dimensional coordinates are calculated based on the position of the optical measuring device.

It can be provided that the point sensor works according to one of the following measuring principles: laser triangulation, confocal or confocal-chromatic distance measurement, interferometric distance measurement, double frequency comb spectroscopy or the like.

It can be provided that the optical measuring system has a single point sensor for optical distance measurement.

It can be provided that the optical measuring system has two or more point sensors for optical distance measurement.

It can be provided that point sensors are lined up along a line or arranged in a grid-like manner in rows and columns. It can be provided that one or more point sensors work according to one of the measurement principles listed below: laser triangulation, confocal or confocal-chromatic distance measurement, interferometric distance measurement, double frequency comb spectroscopy or the like. Each of the point sensors is therefore set up, in particular, in the manner described above for optical distance measurement and has, in particular, a depth resolution along an optical axis. The point sensors can record measured values at the same time.

In particular, the optical measuring system does not have a camera. In particular, the optical measuring system does not have a camera for two-dimensional imaging.

It can be provided that, in particular, no camera is used to create measuring points by image or pixel analysis or image processing. In particular, no camera for two-dimensional imaging is used for the acquisition of measuring points by image or pixel analysis or image processing.

Measurement points are recorded in particular on the respective tooth flanks of a tooth system at a distance from the edge regions of the respective tooth flanks.

It can be provided that an optical axis of the optical measuring system encloses an angle with the tooth flank that is not equal to 90° during the acquisition of a measuring point on a tooth flank. In other words, it can be provided that a normal on the tooth flank starting from the measuring point is not oriented collinearly to the optical axis.

It can be provided that several measuring points are recorded on a respective tooth flank along a tooth width, i.e. in the direction of the tooth trace. It can be provided that several measurement points along a tooth width, i.e. in the direction of the tooth trace, are recorded as individual measurement points on a respective tooth flank, with a first individual measurement point in the direction of the tooth trace being recorded before a second individual measurement point in the direction of the trace.

The terms tooth flank and flank are used synonymously here.

It can be provided that the determination of one or more geometric parameters of the toothing based on the profile segments is performed analogously to the evaluation of a tactile measurement and/or is performed with evaluation software for evaluating a tactile measurement. The filtering and modeling therefore enables, in particular, the application of evaluation algorithms that are optimized for a tactile measurement to the results of the optical measurement.

According to a second aspect, the disclosure relates to a device, having a measuring device, wherein the measuring device comprises an optical measuring system, having a holder for holding a component, having a control and evaluation unit, adapted for carrying out the method according to the disclosure.

The measuring device can be a coordinate measuring device. The coordinate measuring device can have numerically controlled axes in order to carry out a relative movement between the component to be measured and the optical measuring device before and/or during and/or after the measurement.

The coordinate measuring device can have an axis of rotation in order to rotate a component to be measured about its own axis during the measurement.

The coordinate measuring device can have at least one linear axis, two or more linear axes, three or more linear axes or precisely three linear axes in order to move the optical measuring system relative to the component to be measured.

In addition to the optical measuring system, the coordinate measuring device can have a tactile measuring system in order to measure a component tactilely by touching it with a measuring probe.

### BRIEF DESCRIPTION OF THE DRAWINGS

The disclosure is described in more detail below with reference to a drawing illustrating exemplary embodiments. The drawings show schematically in each case:

FIG. 1A an optical measurement;

FIG. 1B a tactile measurement;

FIG. 2A a component to be measured;

FIG. 2B an optical measurement of the component to be measured from FIG. 2A

FIG. 3A measuring points of the optical measurement;

FIG. 3B a magnified view of the measuring points of the optical measurement from FIG. 3A;

FIG. 3C measuring points of the optical measurement from FIG. 3B before radial filtering;

FIG. 3D measuring points of the optical measurement from FIG. 3B after radial filtering;

FIG. 3E measuring points of the optical measurement from FIG. 3D before profile-specific filtering;

FIG. 3F measuring points of two flank groups of the optical measurement from

FIG. 3D of the profile-specific filtering;

FIG. 3G modeled profile segments of two flank groups with the nominal geometry;

FIG. 3H modeled profile segments in a general overview;

FIG. 3I modeled profile segments in a general overview with the nominal geometry and a compensation geometry;

FIG. 3J measuring points of the flank groups of the optical measurement from

FIG. 3D after radial filtering and after profile-specific filtering in a general overview;

FIG. 4A a deviation of a left profile segment to a left averaged compensation profile segment;

FIG. 4B a deviation of a right profile segment to a right averaged compensation profile segment;

FIG. 4C a deviation of a left profile segment to another left profile segment;

FIG. 4D a deviation of a right profile segment to another right profile segment;

FIG. 4E a deviation of a left averaged compensation profile segment from the nominal geometry;

FIG. 4F a deviation of a right averaged compensation profile segment from the nominal geometry; and

FIG. 5 a flow chart of the method according to the disclosure.

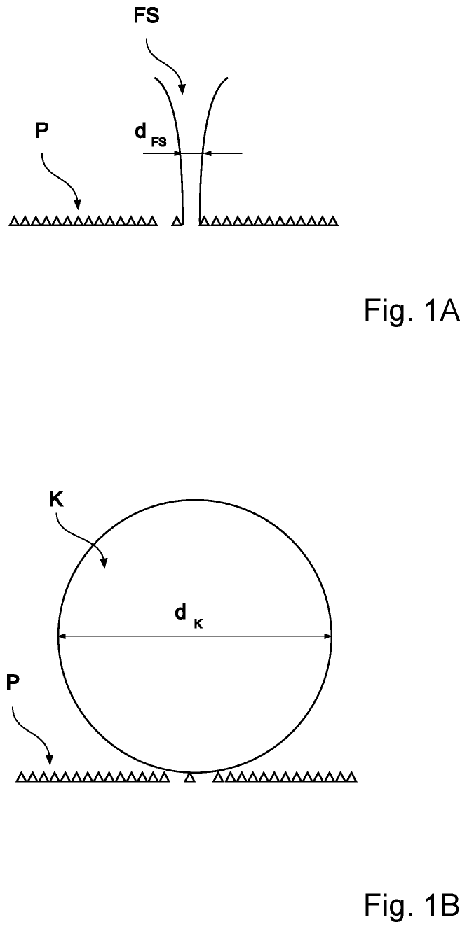

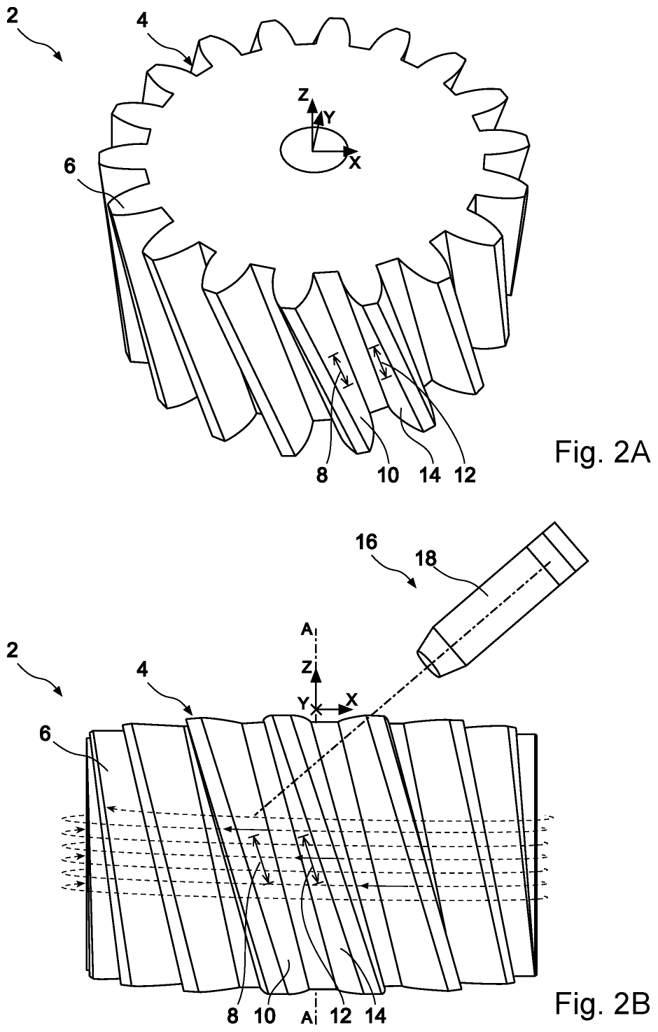

### DETAILED DESCRIPTION OF THE DRAWINGS

FIG. 2A shows a component 2 with a toothing 4. The component 2 is a helical spur gear 2 with an involute toothing 4. The tooth pitch of the toothing 4 is to be measured on the helical spur gear 2. For this purpose, a flank line section 8 on a left flank 10 and a flank line section 12 on a right flank 14 are to be measured on each tooth 6 of the toothing 4. Exemplarily, a flank line section 8 on a left flank 10 and a flank line section 12 on a right flank 14 of two adjacent teeth 6 are shown.

The spur gear 4 is measured by means of a measuring device 16, which has an optical measuring system 18 (step (I)). During the measurement, the spur gear 2 rotates continuously about its own axis, which can in particular be aligned collinearly to the z-axis of the Cartesian coordinate system x-y-z. It will be understood that any other Cartesian coordinate system or polar coordinate system may also be used.

In addition to the rotation about the z-axis, a linear relative movement takes place in the z-direction, resulting in the measuring path indicated by the dashed lines, which covers the flank line sections 8, 12 of all teeth 6 to be measured. Thereby, the optical measuring system 18 measures the complete tooth profiles, including the tooth tip, the tooth flank and the tooth root of each tooth.

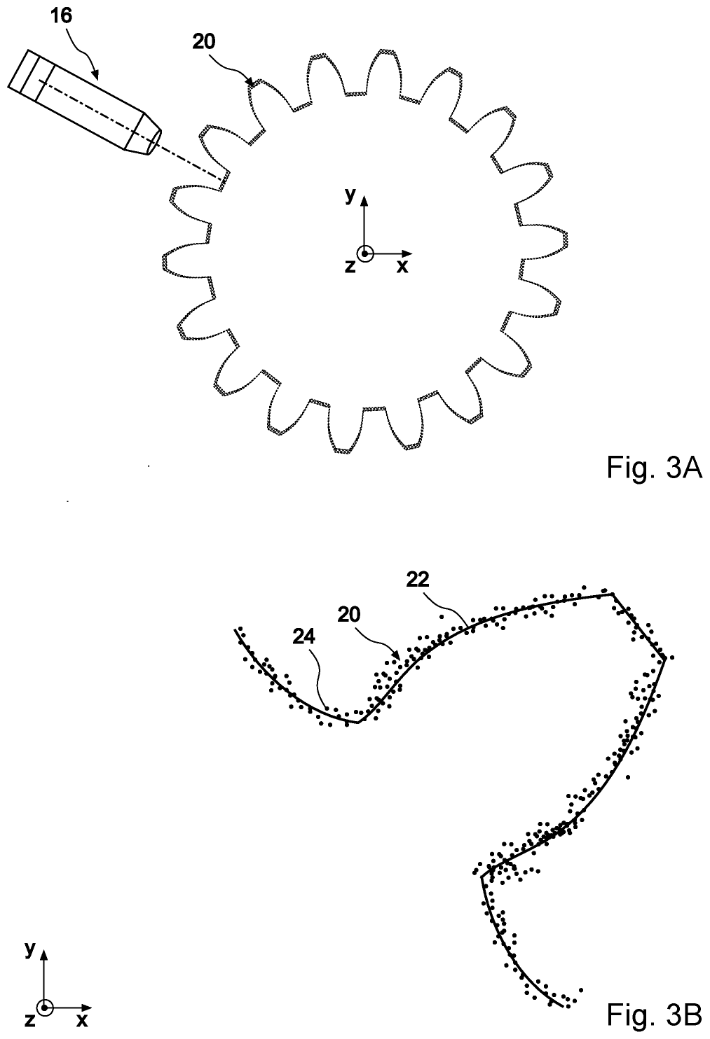

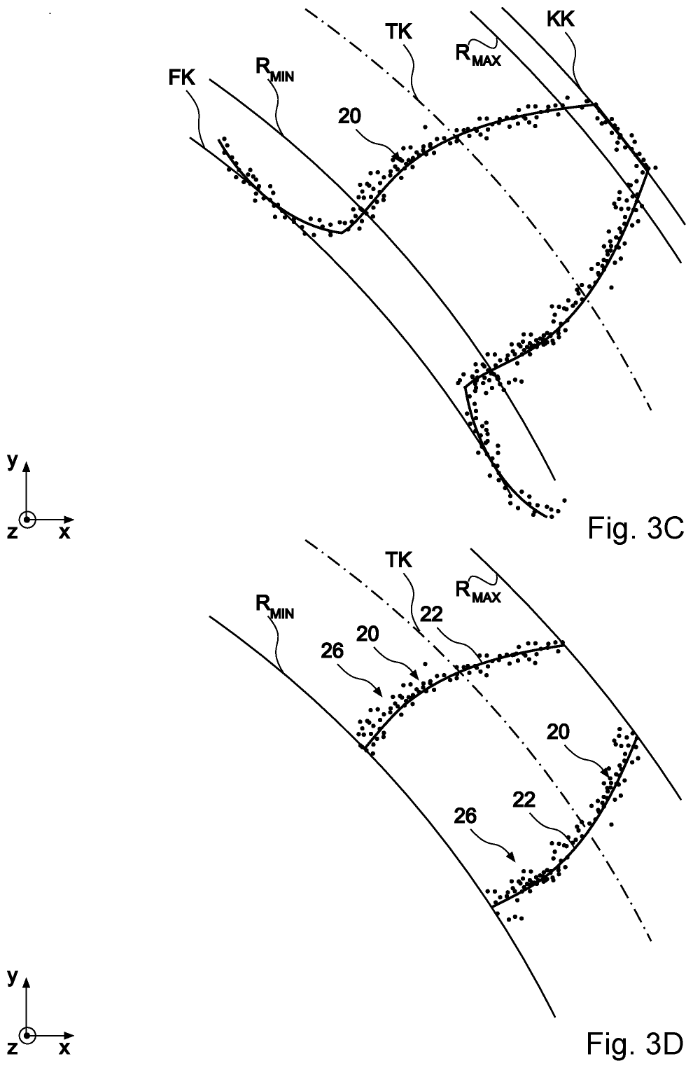

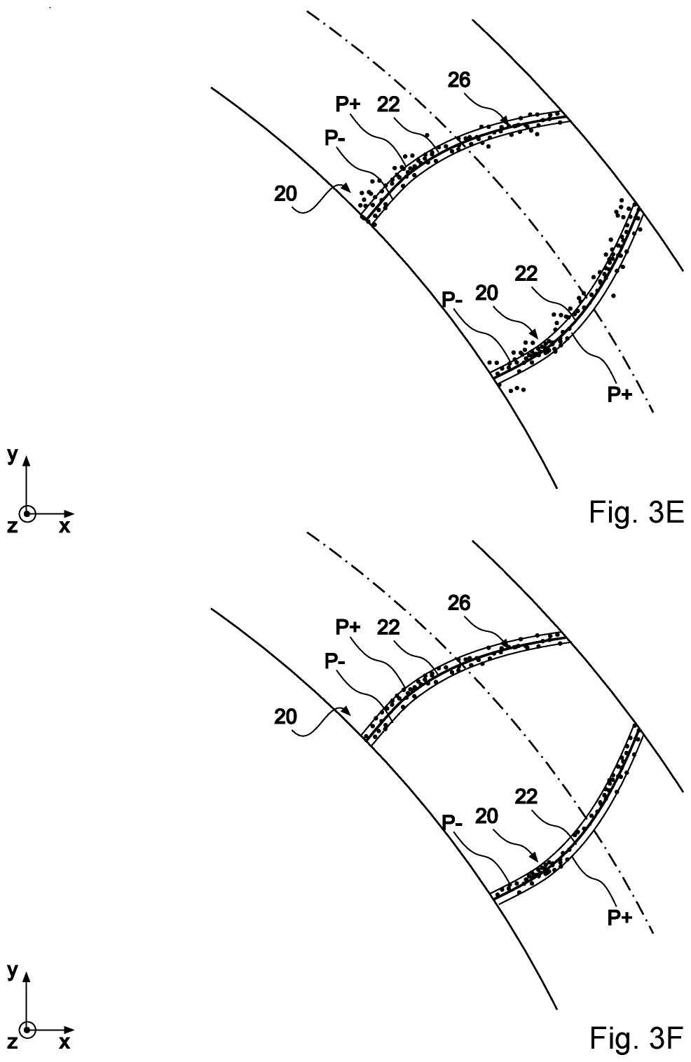

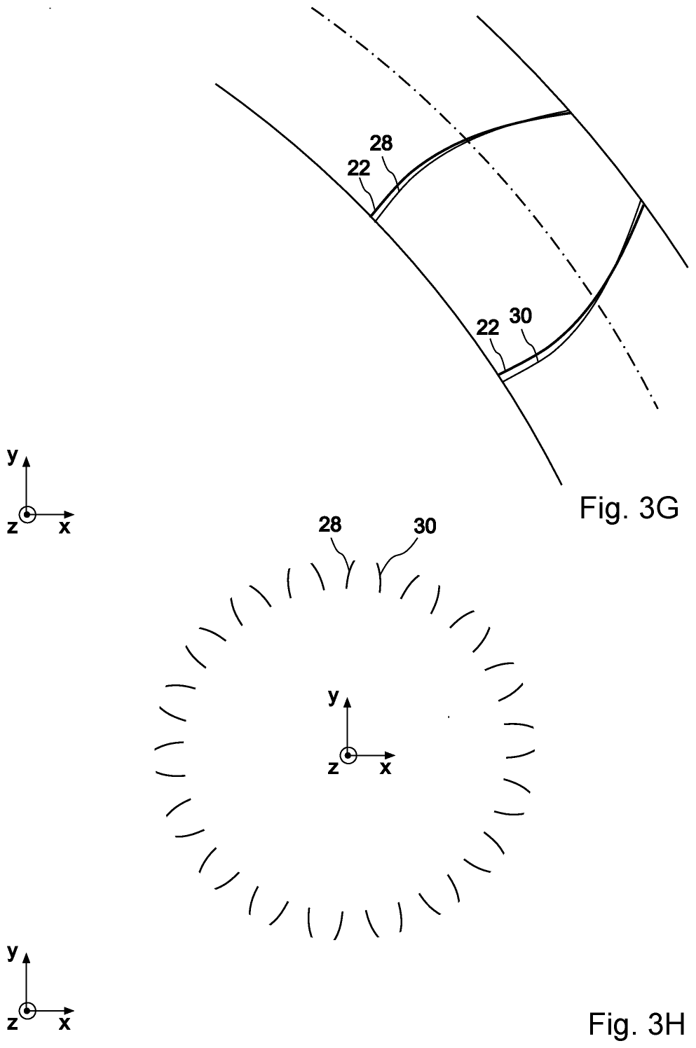

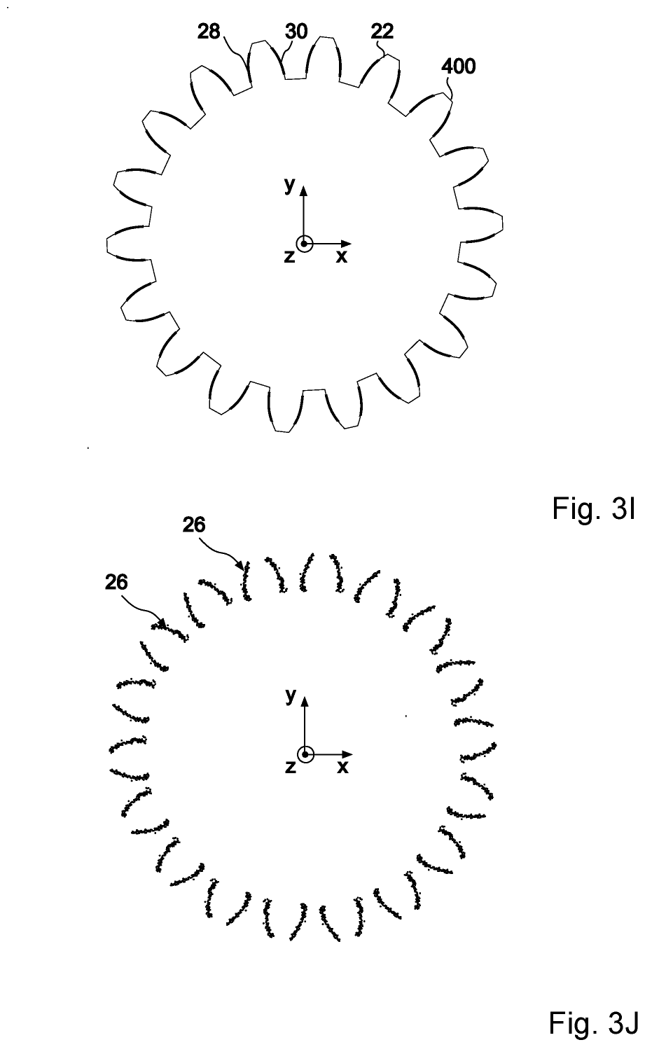

A plurality of measuring points 20 are therefore acquired, wherein the measuring points 20 are shown in FIG. 3A for a view in traverse section. FIG. 3B shows an enlarged view of measuring points 20 of a tooth in traverse section, wherein a section of a predetermined nominal geometry 22 of the toothing 4 is shown in the form of a profile line 22. Each individual measuring point 24 of the plurality of measuring points 20 is defined by an x-value, a y-value and a z-value, i.e. its position in space according to the Cartesian coordinate system x-y-z.

In a next step, the measuring points 20 are grouped into flank groups 26 by filtering (step (II)).

FIGS. 3C and 3D illustrate a radial filtering of the measuring points 20, wherein all measuring points 20 of the flank groups 26 are located between a predetermined circle R_{MIN} having a minimum radius and a predetermined circle R_{MAX} having a maximum radius. The radius of the circle R_{MIN} is larger than a radius of the root circle FK of the toothing 4. The radius of the circle R_{MAX} is smaller than a radius of the tip circle KK of the toothing 4. Further, the pitch circle TK is drawn.

If the radial filter shown in FIG. 3C is applied to the measuring points, all measuring points outside the filter band bounded by R_{MIN} and R_{MAX} are sorted out or masked out or deleted. The measuring points 20 remaining after radial filtering are shown in FIG. 3D. For better clarity, those areas of the nominal profile 22 which do not lie between R_{MIN} and R_{MAX} are now also masked out.

This radial filtering already defines the number of flank groups 26, which may also be referred to as contiguous measuring sections 26. The result of the radial filtering is further illustrated in FIG. 3J, which shows the flank groups 26 for all teeth 6 of the toothing 4, wherein only two flank groups 26 have been provided with a reference sign.

It is now checked whether the number of flank groups 26 corresponds to twice the number of teeth of the toothing 4, wherein the number of teeth here are equal to 18 (step (III)). In the present case, the check shows that the number of flank groups 26 corresponds to twice the number of teeth, since 36 flank groups have been generated. Therefore, the radial filtering check is positive and the radial filtering does not need to be adjusted. Each individual left flank and each individual right flank of the toothing is therefore associated with one flank group 26 and one contiguous measuring section 26 respectively.

It is further checked whether each of the respective flank groups has a sufficient number of measuring points and whether these measuring points of a respective flank group are sufficiently evenly distributed (step (III)).

In a next step, a profile-specific filtering is performed, wherein all measuring points 20 of a respective flank group 26 have a respective minimum distance to the predetermined nominal geometry 22 of the toothing 4 which does not exceed a predetermined distance. This means that each of the flank groups 26 is filtered again, as will be described with reference to FIGS. 3E and 3F below (step (IV)).

For each flank group 26, according to FIGS. 3E and 3F, those measuring points 20 are sorted out or masked out or deleted that do not lie within a band bounded by lines P+ and P−, wherein P+ and P− are substantially offset profile lines of the target profile. FIG. 3F shows the flank groups 26 after applying the profile-specific filtering.

Furthermore, a kinematic filtering of the measuring points 20 is performed, wherein all measuring points 20 of the flank groups 26 satisfy the condition that at the time of detection of the respective measuring point 20 an amount of an acceleration of a machine axis A of the measuring device 16 performing a measuring movement is smaller than a predetermined threshold value, wherein the machine axis A is a spindle axis A performing the rotation, which spindle axis A is extended along the z-axis and carries the component 2 (step (IV)).

In addition, qualitative filtering of the measuring points 20 is performed, wherein all of the measuring points 20 of the flank groups 26 satisfy the condition of not falling below a predetermined exposure time and/or a predetermined intensity during the imaging of a respective measuring point 24 (step (IV)).

For each flank group 26, a profile segment 28, 30 is then modeled in each case as a mathematical non-linear function of higher order, wherein profile segments of left flanks 10 are designated as profile segments 28 and profile segments of right flanks 14 are designated as profile segments 30 (FIG. 3G, FIG. 3H). In the manner described above, the profile segments 28, 30 can be created for each height z in order to represent the measured tooth flanks (step (V)).

Alternatively or additionally, it can be provided that the three-dimensionally defined measuring points of all flank groups are projected into a two-dimensional plane before filtering, wherein the modeling of profile segments from the measuring points in the two-dimensional plane takes place as two-dimensional profile segments. By projecting the measuring points onto the two-dimensional plane along the flank line, averaging can be performed according to tactile measurement.

The determination of one or more geometric parameters of the toothing on the basis of the profile segments 28, 30 can be carried out analogously to the evaluation of a tactile measurement and, in particular, can be carried out by means of evaluation software for evaluating a tactile measurement in order to determine the tooth pitch on the basis of the flank lines 8, 12 and other geometric parameters of the toothing (step (VI)).

Alternatively or additionally, a respective flank line 8, 12 may be directly generated by filtering and modeling using the aforementioned method.

Prior to the evaluation and determination of geometric parameters of the toothing, a plausibility check of the modeled profile segments can be performed, using one or more of the following method steps:

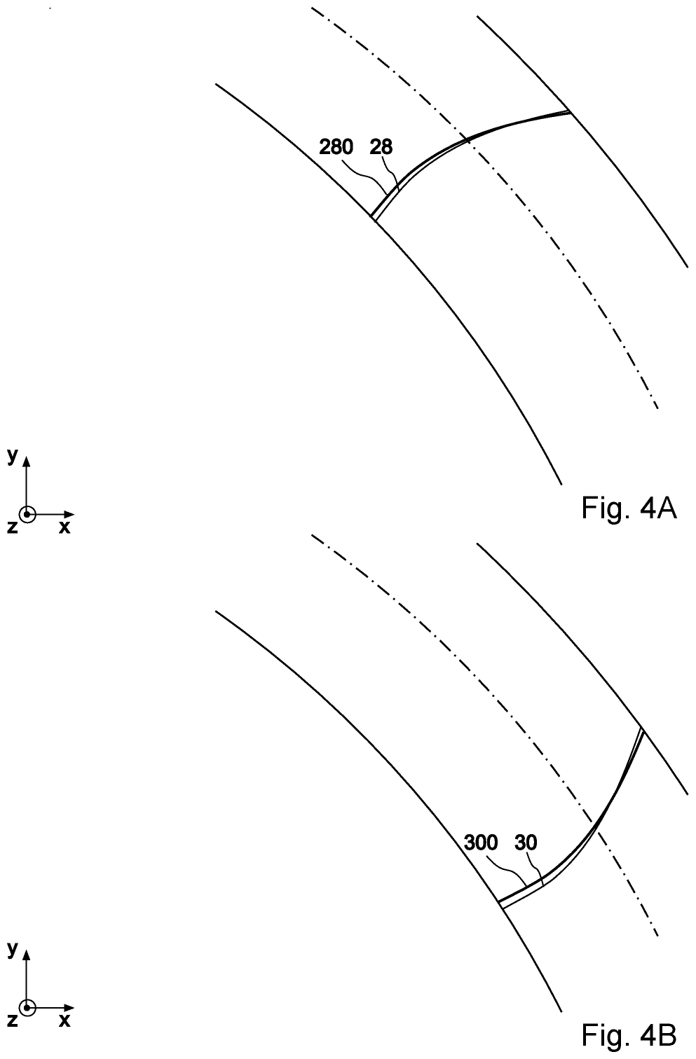

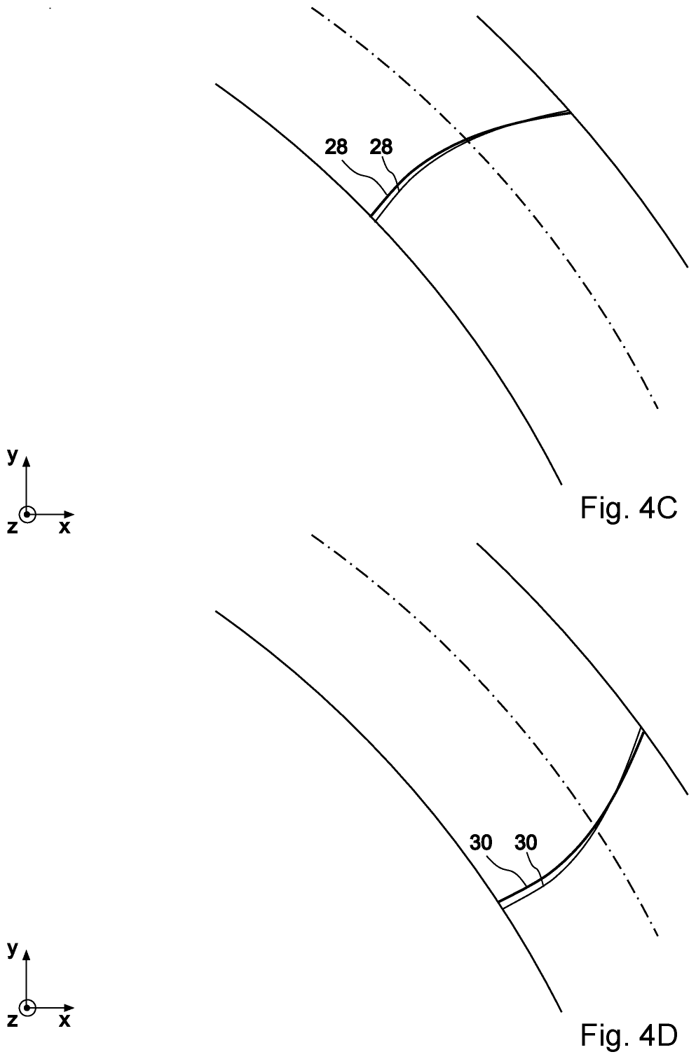

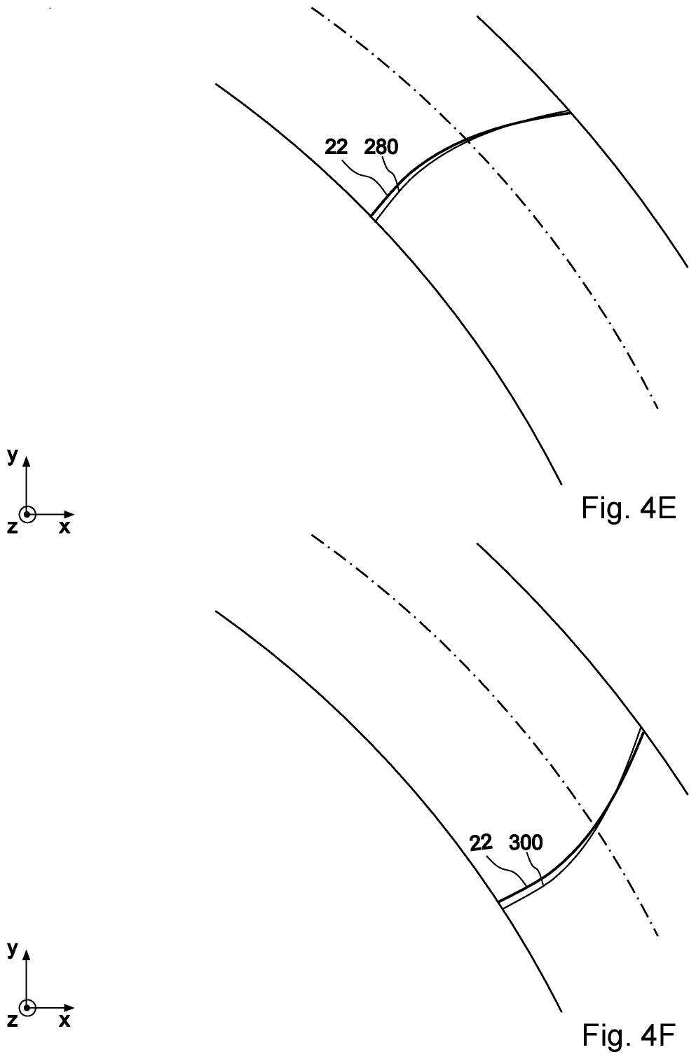

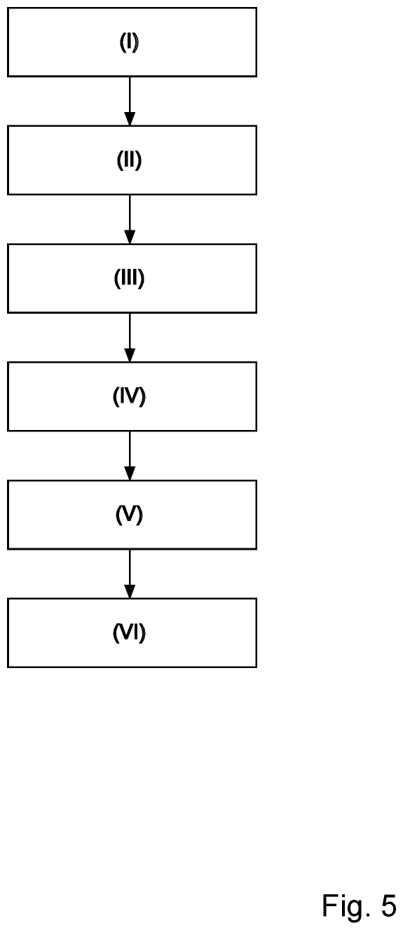

Creating a left averaged compensation profile segment 280 from profile segments 28 of left flank groups 26, and checking a deviation of at least one profile segment 28 of a left flank group 26 from the left averaged compensation profile segment 280 (FIG. 4A).

Creating a right averaged compensation profile segment 300 from profile segments 30 of right flank groups 26, and checking a deviation of at least one profile segment 30 of a right flank group 26 from the right averaged compensation profile segment 300 (FIG. 4B).

Checking a deviation of at least one profile segment 28 of a left flank group 26 from another profile segment 28 of a left flank group 28 (FIG. 4C).

Checking a deviation of at least one profile segment 30 of a right flank group 26 from another profile segment 30 of a right flank group 26 (FIG. 4D).

Checking a deviation of the left averaged compensation profile segment 280 from the predetermined nominal geometry and checking a deviation of the right averaged compensation profile segment 300 from the predetermined nominal geometry (FIG. 4E; FIG. 4F).

Checking a deviation of at least one profile segment 28, 30 from the predetermined nominal geometry 22 and/or from a compensation geometry 400, wherein the compensation geometry 400 has been determined from the profile segments 28, 20 of the flank groups 26 (FIG. 3I). In the schematic representation of FIG. 3I, the nominal geometry 22 and the compensation geometry 400 are drawn congruent, although in reality they are not exactly congruent.

1. A method including, the following steps:
providing a component, wherein the component has a toothing with a predetermined nominal geometry;
providing a measuring device, wherein the measuring device comprises an optical measuring system;
measuring the toothing of the component using the optical measuring system, wherein measuring points are detected; and
evaluating measuring points; wherein
evaluating of the measuring points includes at least the following steps:
grouping of the measuring points into flank groups by filtering;
modeling of profile segments from the measuring points of the flank groups, wherein a profile segment is assigned to each flank group; and
determining one or more geometric parameters of the toothing on the basis of the profile segments.

2. The method according to claim 1, wherein
the grouping of the measuring points into flank groups by filtering includes one or more of the following method steps:
radial filtering of the measuring points, wherein a plurality of the measuring points of the flank groups lie between a predetermined minimum radius and a predetermined maximum radius;
profile-specific filtering of the measuring points, wherein a plurality of the measuring points of the flank groups are each at a minimum distance from the predetermined nominal geometry of the toothing which does not exceed a predetermined distance;
kinematic filtering of the measuring points, wherein a plurality of the measuring points of the flank groups satisfy the condition that, at the time of detection of the respective measuring point, an amount of an acceleration of a machine axis of the measuring device performing a measuring movement is smaller than a predetermined threshold value; and
qualitative filtering of the measuring points, wherein a plurality of the measuring points of the flank groups satisfy the condition that during the imaging of a respective measuring point an exposure time does not fall below a predetermined exposure time and/or an intensity does not fall below a predetermined intensity.

3. The method according to claim 1, wherein
the grouping of the measuring points into flank groups by filtering comprises one or more of the following test steps:
checking whether the number of flank groups corresponds to a double number of teeth of the toothing;
checking whether the number of measuring points of a respective flank group exceeds a predetermined minimum number;
checking whether the measuring points of a respective flank group have a predetermined distribution; and
wherein the test steps are carried out before the modeling.

4. The method according to claim 1, wherein
the modeling of profile segments from the measuring points of the flank groups, wherein a profile segment is assigned to each flank group, comprises one of the following method steps:
modeling of at least one profile segment as a mathematical non-linear function of higher order, or
modeling of several profile segments each as a mathematical nonlinear function of higher order, or
modeling of all profile segments each as a mathematical nonlinear function of higher order.

5. The method according to claim, 1 wherein
the modeling of profile segments from the measuring points of the flank groups, wherein a profile segment is assigned to each flank group, comprises a plausibility check having one or more of the following method steps:
creating a left averaged compensation profile segment from profile segments of left flank groups and checking a deviation of at least one profile segment of a left flank group from the left averaged compensation profile segment;
checking a deviation of at least one profile segment of a left flank group from another profile segment of a left flank group;
creating a right averaged compensation profile segment from profile segments of right flank groups and checking a deviation of at least one profile segment of a right flank group from the right averaged compensation profile segment;
checking a deviation of at least one profile segment of a right flank group from another profile segment of a right flank group;
checking a deviation of the left averaged compensation profile segment from the specified nominal geometry;
checking a deviation of the right averaged compensation profile segment from the specified nominal geometry;
checking a deviation of at least one profile segment from the predetermined nominal geometry and/or from a compensation geometry, wherein the compensation geometry has been determined from the profile segments of the flank groups; and
checking a deviation of a first profile segment of a tooth of the toothing of a first measurement from a second profile segment of the same tooth of a second measurement.

6. The method according to claim 5, wherein
an adjustment of the filtering and/or
an adjustment of a measurement parameter takes place
if a deviation exceeds a predefined threshold value.

7. The method according to claim 1, wherein
three-dimensional measuring points of at least one flank group, several flank groups or all flank groups are projected into a two-dimensional plane, in before profile segments are created, wherein the modeling of profile segments from the measuring points takes place in the two-dimensional plane as two-dimensional profile segments; or
a three-dimensional profile segment of a flank group, three-dimensional profile segments of several flank groups, or three-dimensional profile segments of all flank groups are projected into a two-dimensional plane.

8. The method according to claim 1, wherein
a tooth pitch is one of the one or more geometric parameters of the toothing and the tooth pitch is determined on a pitch measuring circle and/or
a pitch deviation is one of the one or more geometrical characteristics of the toothing.

9. The method according to claim 1, wherein
the component is continuously moved relative to the optical measuring system during the acquisition of the measuring points and/or
a focal diameter of the optical measuring system is 50 micrometers or less, and/or
the determination of one or more geometric parameters of the toothing on the basis of the profile segments is carried out analogously to the evaluation of a tactile measurement and/or is carried out with an evaluation software for the evaluation of a tactile measurement.

10. A device,
having a measuring device, wherein the measuring device comprises an optical measuring system,
having a holder for holding a component,
having a control and evaluation unit, adapted for carrying out a method including the following steps:
providing a component having a toothing with a predetermined nominal geometry;
providing the measuring device;
measuring the toothing of the component using the optical measuring system, wherein measuring points are detected; and
evaluating measuring points including at least the following steps:
grouping of the measuring points into flank groups by filtering;
modeling of profile segments from the measuring points of the flank groups, wherein a profile segment is assigned to each flank group; and
determining one or more geometric parameters of the toothing on the basis of the profile segments.
